(19) United States
(12) Patent Application Publication
(10) Pub. No.: US 2007/0217400 A1
(43) Pub. Date: Sep. 20, 2007

(54) Audio distribution over internet protocol

(76) Inventor: Mathew L. Staples, Fort Collins, CO (US)

Correspondence Address: TRENNER LAW FIRM, LLC, 12081 WEST ALAMEDA PARKWAY #163, LAKEWOOD, CO, 80228, US

(21) Appl. No.: 11/377,952

(22) Filed: Mar. 17, 2006

(51) Int. Cl. H04L 12/66

(52) U.S. Cl. 370/356

(57) ABSTRACT

Systems and methods for distributing audio locally over Internet Protocol (IP) are disclosed. The system may comprise a first host machine having a process hub (PHub) for handling local communications with a plurality of process spokes (PSpokes) on the first host machine, and a second host machine having a process hub (PHub) for handling local communications with a plurality of process spokes (PSpokes) on the first host machine. A local area network connects the first and second host machines via the respective PHubs. An audio channel is established on the local area network for communicating audio using Internet Protocol between devices controlled by the PSpokes on the first and second host machines.

### TECHNICAL FIELD

The described subject matter relates to audio systems in general, and more particularly to audio distribution over Internet Protocol (IP).

### BACKGROUND

People enjoy music from a variety of sources, e.g., a collection of compact discs (CDs), music downloads, and the radio. Accordingly, many homeowners have a wide variety of different types of audio/visual (AV) (e.g., radios and CD players) and other media devices to play music, video, etc. from these different sources. Some homeowners even have dedicated media rooms for their equipment.

Traditional devices limit the user experience to a particular location. By way of illustration, if a user is listening to a CD in the media room, and wants to go into another room, the user has to stop listening to the CD, or stop the CD and bring it along to the other room. If the user wants to listen to something different, he or she must return to the media room, retrieve the desired CD, and bring it back to the room where lie or she will be listening to it.

Some users copy music/video from their CD/DVD collection and other sources into a computer-readable format (e.g., MP3 format). This allows the user to mix and match different types of music on a single portable device, such as an MP3 player. However, even portable devices must be carried with the user from one location to another. In addition, the user can only make selections from a single source, e.g., only that which has been transferred to the MP3 player.

### SUMMARY

An exemplary system for distributing audio locally over Internet Protocol comprises a first host machine having a process hub (PHub) for handling local communications with a plurality of process spokes (PSpokes) on the first host machine. A second host machine is also provided having a process hub (PHub) for handling local communications with a plurality of process spokes (PSpokes) on the first host machine. A local area network connects the first and second host machines via the respective PHubs, wherein the PHubs communicate audio using Internet Protocol between devices controlled by the PSpokes on the first and second host machines. An audio channel may be established on the local area network for communicating audio using Internet Protocol between devices controlled by the PSpokes on the first and second host machines.

An exemplary method comprises: discovering audio devices on a local area network in a hub and spoke system, establishing a UDP multicast channel between at least some of the audio devices in the local area network, and streaming audio over the UDP multicast channel.

Another exemplary audio system comprises hub and spoke means for discovering audio devices on a local area network. The system also comprises means for establishing an audio distribution channel between the discovered audio devices. The system also comprises means for multicasting audio data over the audio distribution channel.

### BRIEF DESCRIPTION OF THE DRAWINGS

FIG. 1 is network diagram illustrating various components of an exemplary audio distribution system as it may be implemented in a home or other building.

FIG. 2 is a schematic diagram of an exemplary audio distribution system as it may be implemented using a hub and spoke configuration.

FIG. 3 is a high-level illustration of an exemplary inter-PHub message.

FIG. 4 is a high-level illustration of an exemplary UDP packet formatted for transmitting audio in an IP multicast.

FIG. 5 is a flow diagram showing exemplary operations which may be implemented for audio distribution over IP.

### DETAILED DESCRIPTION

Briefly, exemplary systems and methods described herein may be implemented to provide digital audio in a distributed environment. The system enables audio distribution using network-enabled devices and/or non-network enabled Consumer Electronics (CE) devices, such as, e.g., commercially available touch-screen displays or other input devices; commercially available CD and MP3 players or other audio sources; and commercially available amplifiers or other audio output devices. The distributed environment may include audio sources centrally located in the media room and/or at various locations in a house, and the audio sources may be accessed from any of a variety of different zones (e.g., different rooms of the house) via the network.

In an exemplary embodiment, the system is implemented using a “hub and spoke” configuration, e.g., including at least one process hub (or “PHub”) and a plurality of process spokes (or “PSpokes”). The hub and spoke system discovers and communicatively couples the devices in the system to one another using a suitable protocol, such as, e.g., Internet Protocol (or “IP”). The audio may be transmitted between the devices by User Datagram Protocol (UDP) packets in an IP multicast.

Although exemplary implementations are described herein with reference to home audio, it is noted that the scope is not limited to such use. The invention may also find application in a number of different types of environments.

Exemplary Systems

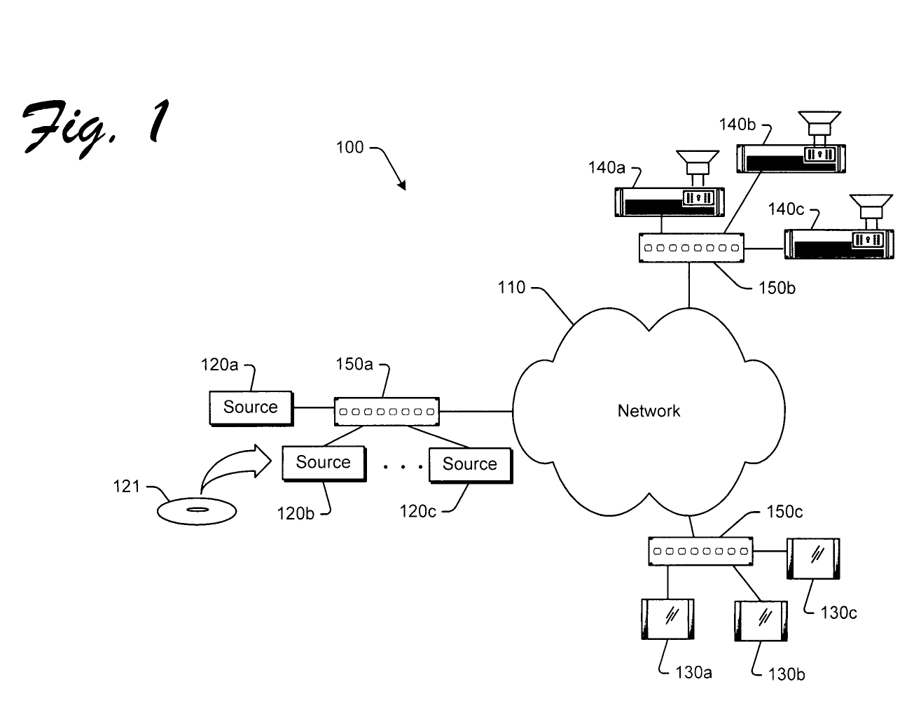

FIG. 1 is network diagram illustrating various components of an exemplary audio distribution system 100 as it may be implemented in and around a house or other building. Exemplary system 100 may be implemented on a local area network (LAN) 110, e.g., an Ethernet network. Any number of audio sources 120a-c, input devices 130a-c, and audio output devices 140a-c may be connected to the network 110. The input devices 130a-c enable a user to select audio from the one or more of the audio sources 120a-c and render the selected audio at one or more output devices 140a-c in the system 100.

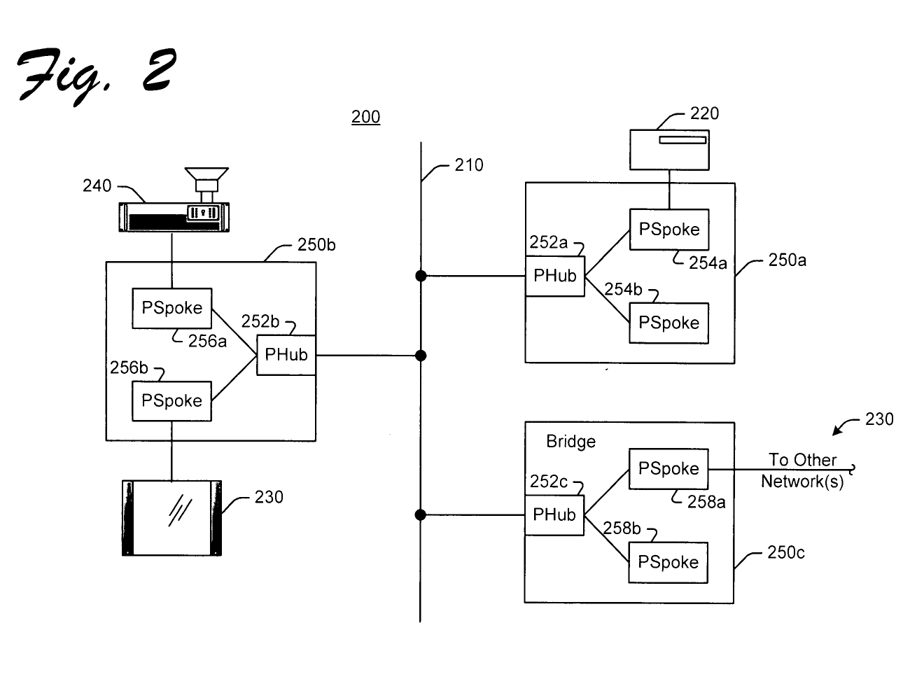

In an exemplary embodiment, the audio sources 120a-c, input devices 130a-c, and audio output devices 140a-c are connected to the network via IP-based host machines 150a-c. Host machines 150a-c are described in more detail below with reference to FIG. 2. For now, it is sufficient to understand that host machines 150a-c may be implemented as computing devices including at least a processor and system memory. The system memory may include read only memory (ROM) and random access memory (RAM). A basic input/output system (BIOS) containing the basic routines that help to transfer information between elements within computing device, such as during start-up, may be stored in ROM. The operating system and application software may be stored on a hard disk drive or other computer-readable media and accessed via RAM during execution.

Exemplary audio sources 120a-c may include any of a variety of consumer electronics (CE) devices capable of reading media, such as, e.g., compact discs (CDs), AM/FM or satellite radio signals, computer-readable files, and even media stored on older types of media storage devices (e.g., cassette tapes), to name only a few examples. System-specific, network-enabled devices may also be implemented.

Exemplary input devices 130a-c may include any of a variety of consumer electronics (CE) devices capable of receiving user input, such as, e.g., personal computers (PCs), touch-panel displays, keypads, and remote control devices, to name only a few examples. Other network-enabled devices may also be implemented. System-specific, network-enabled devices may also be implemented.

Exemplary audio output devices 140a-c may include any of a variety of consumer electronics (CE) devices capable of rendering audio, such as, e.g., stereo amplifiers and home theater systems, to name only a few examples. System-specific, network-enabled devices may also be implemented.

Although audio sources 120a-c, input devices 130a-c, and audio output devices 140a-c are shown in FIG. 1 each being providing on separate host machines 150a-c, respectively, the system 100 is not limited to such a configuration. Other embodiments are also contemplated, e.g., wherein audio sources 120a-c, input devices 130a-c, and/or audio output devices 140a-c are provided on the same host machine(s) (see, e.g., the exemplary configuration in FIG. 2).

During operation, the input devices 130a-c may be implemented to generate an audio selection signal. In response, the audio source 120a-c generates an audio stream which is output by the selected output device(s) 140a-c. In addition, the input device may be implemented to generate control signals for the audio sources, such as, e.g., Stop, Play, Fast-forward, Rewind, and Pause.

The audio sources 120a-c may also distribute meta-data corresponding to the audio stream. For purposes of illustration, the meta-data may include the title, artist, song length, station frequency, call letters, genre, etc. The audio sources 120a-c may also distribute control information (e.g., bass, treble) which may be implemented at the output device(s) 140a-c to control output.

The system 100 may be implemented in a hub and spoke environment. A hub and spoke system discovers devices and enables logical connections to communicatively couple one or more of the audio sources 120a-c, input devices 130a-c, and output devices 140a-c, e.g., using Internet Protocol (or “IP”), as explained in more detail below with reference to FIG. 2.

FIG. 2 is a schematic diagram of an exemplary audio distribution system as it may be implemented using a hub and spoke configuration. As discussed above, audio distribution system 200 may include one or more audio source device 220, input device 230, and audio output device 240 communicatively coupled to one another over a network 210 via IP-based host machines 250a-c.

These devices may be physically connected via encoder or decoder devices. Encoder and decoder devices may be implemented as analog to digital (A/D) conversion devices for converting analog signals (e.g., an audio signal or command signal) into a digital signal (e.g., PCM audio stream) for transmission over the network.

It is noted that source device 220, input device 230, and audio output device 240 may be communicatively coupled to one another locally (i.e., via the same host machine), and/or remotely (i.e., via different host machines). In FIG. 2, for example, input device 230 and audio output device 240 are shown connected locally via host machine 250b, and remotely to source device 220 via host machine 250c. A bridge host device 250c is also shown in FIG. 2 for connecting the source device 220, input device 230, and/or audio output device 240 to other networks (e.g., a CAN bus). In addition, a single device may include functionality of a source device, input device, and/or audio output device.

A hub and spoke configuration may be implemented as the communication backbone. This communication backbone discovers, connects, and controls machines on the network. In a hub and spoke configuration, application processes on the host machines communicate with each other through a communications infrastructure of process hubs (“PHubs”) and process spokes (“PSpokes”). The PHubs and PSpokes may be implemented in software, e.g., for execution in a LINUX operating environment. For purposes of illustration, PSpoke 254a may include audio encoder software for receiving an audio signal, e.g., from CE device 220, and converting the audio signal into a computer-readable audio stream. PSpoke 256a may include audio rendering software for receiving a computer-readable audio stream and outputting it, e.g., at CE device 240. PSpoke 256b may include user interface software for interfacing with a user, e.g., via CE device 230.

Each host machine 250a-c hosts a single instance of the PHub process. For example, host machine 250a-c host PHub processes 252a-c in FIG. 2. Each PHub 252a-c is responsible for routing all communications between the PSpokes on that host machine. For example, PHub 252a routes communications on host machine 250a to PSpokes 254a-b, PHub 252b routes communications on host machine 250b to PSpokes 256a-b, and PHub 252c routes communications on host machine 250c to PSokes 258a-b. Each application process has a single PSpoke, which is used to attach to the local PHub, and to communicate with other PSpokes (via the PHub) on the local host machine (or a remote host machine).

Each PSpoke has an associated address that is unique in the system. This address allows a PHub to route messages between PSpokes on its local machine, or to PSpokes on remote machines (inter-pHub messages), or both. The application process can therefore use a PSpoke address as a handle to another application process without having to know the location of that process in the system 200.

During operation, all messages from the PSpokes are routed to the local PHub, which determines if the message is for the local host machine (e.g., another local PSpoke) or for a remote host machine. If the message is for a remote host machine, the message is “wrapped” in an IP packet and broadcast (i.e., without addressing) or addressed via the network 210 to the remote host machine.

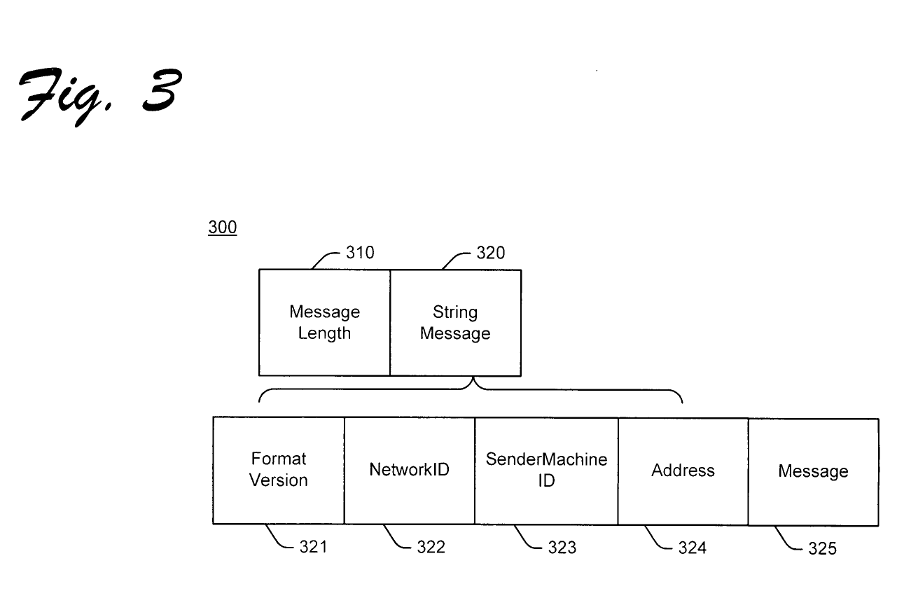

Audio distribution in this hub and spoke system may be accomplished by establishing a separate channel, e.g., between the audio input device and the audio output device, over which the audio stream is sent via IP packets, as described in more detail below with reference to FIG. 3.

FIG. 3 is a high-level illustration of an exemplary inter-PHub message 300. Exemplary inter-PHub messages 300 include a two byte little-endian length field 310 indicating the length of the remainder of the message. Following the length field is a string message 320. The string message 320 may include a FormatVersion field 321, NetworkID field 322, senderMachineID field 323, Address field 324, and Message body 325. Optionally, the string message 320 may also include a return address (not shown).

The FormatVersion field 321 identifies the protocol version. For example, the FormatVersion field 321 may include the number “2” to identify the version of the packet. Later versions may include the number “3” and so forth. The FormatVersion field 321 may be used to seamlessly handle different versions, e.g., for backward compatibility.

The NetworkID field 322 contains the identification of a logical network. Each host machine in the system is configured with a network ID, and any messages received by a device are only processed if the NetworkID field 322 of the message matches that of the host machine. This mechanism enables multiple logically separate networks to coexist within the same physical IP network.

The SenderMachineID 323 contains a unique ID of the host machine sending the message. The address portion of each message may be formatted as <machine ID><application class ID><process ID>.

The Address field 324 collectively includes the machine ID, application ID, and process ID, each of which are described in more detail as follows.

The machine ID is a unique identifier of a PHub-based device. In an exemplary embodiment, the machine ID, unlike the device's JP address cannot be changed while the device is running. Accordingly, the machine ID does change each time a device reboots, and indicates when a device has rebooted (which may necessitate restarting other services, etc.), without the need for frequent polling of each device in the system.

In an exemplary embodiment, the machine ID may be based on the devices' associated MAC address, although in other embodiments, the machine ID may be any globally unique ID. The following values of machine ID may be implemented, for example, as shown in Table 1.

TABLE 1

| Field Value | Meaning |
|---|---|
| 1 | Local Machine |
| 0 | Unspecified |

It is noted that a bit value of zero is typically used to broadcast to all machines. Leaving the machine ID field blank has the same effect.

The application class ID identifies an application API. A PSpoke process implements one or more APIs, each of which has a known ID. If a PSpoke process implements multiple APIs, messages can be sent to that process using any of the associated application IDs.

In an exemplary embodiment, a PSpoke process has a primary application ID that is used when the PSpoke address of the process is requested. The following values of application class ID may be implemented, for example, as shown in Table 2.

TABLE 2

| Field Value | Meaning |
|---|---|
| 1 | PHub's application ID |
| 0 | Unspecified |

It is noted that a bit value of zero is typically used to broadcast to all application classes, subject to the constraints of the other two address fields. Leaving this field blank also has the same effect.

The process ID is an integer that is unique across a single machine. It is used to differentiate between multiple instances of the same application class. The following values of ProcessID may be implemented, for example, as shown in Table 3.

TABLE 3

| Field Value | Meaning |
|---|---|
| 1 | PHub's process ID |
| 0 | Unspecified |

It is noted that all other process IDs are dynamically determined by the PHub. It is also noted that a bit value of zero is typically used to broadcast to all processes, subject to the constraints of the other two address fields. Leaving this field blank also has the same effect.

In an exemplary embodiment, the message body 325 may be formatted as <message-name>[{<arg1>} . . . {<argN>}]. The message-name field is the name of a command or function, and arg1 through argN are arguments to that command or function. The characters, ‘{’, ‘}’, and ‘:’ are escaped via ‘\’ if they are included in the command/function name or (more typically) within one or more arguments.

The return address (not shown) is an optional field following the message filed 325 that indicates the process address that the message recipient should send response message(s) to. The process address is formatted the same as the (to-) address, except that it may have an optional field, callbackID (also wrapped in “{ }”s). This field may be used in a remote function call mechanism to allow response messages to be matches with their associated request messages.

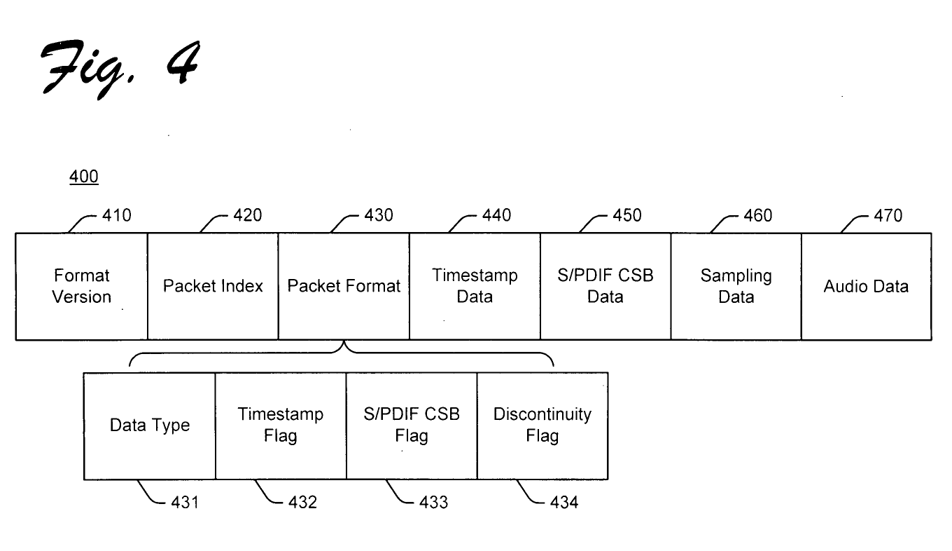

FIG. 4 is a high-level illustration of an exemplary UDP packet 400 formatted for transmitting audio in an IP multicast. In an exemplary embodiment, the UDP packet 400 may be included as the IP message (e.g., message field 325 described above with reference to FIG. 3) for distribution in the IP network. Alternatively, the UDP packet 400 may be issued as is between PSpokes on the same PHub.

Each UDP Packet is formatted with all multi-byte packets (excluding audio data packets). The byte order of audio data packets depends at least to some extent on the content type. The UDP Packets 400 are transmitted in little-endian format, e.g., the 32 bit timestamp values are interpreted as bytes N through N+3, where byte N is the least significant byte. Individual bit fields are given the most significant bit first. For example, the Data Type field 450 is the three most significant bits in the third byte of the packet.

The Format Version Number field 410 indicates the version of the packet scheme. The Packet index field 420 indicates the relative ordering of audio packets. The Packet Format field 430 includes a Data Type field 431, Timestamp Presence Flag 432, S/PDIF Channel Status Block Presence Flag 433, and Discontinuity Flag 434.

In an exemplary embodiment, the Data Type is PCM. However, other formats are also contemplated, such as MP3, AC3 and FLAC. The Timestamp Presence Flag 432 indicates whether a time-of-day timestamp is present in the packet. If present, the Timestamp Data 440 immediately follows the Packet Format field 430.

The Timestamp Data 440 represents the time when the first byte of the audio data in packet 400 should be rendered. In an exemplary embodiment, the first 32 bits of the Timestamp Data 440 is the time of day represented in seconds since Jan. 1, 1970. The second 32 bits is the fractional part of the time in microseconds.

Timestamp Data 440 enables synchronization between the source and its clients (both relative synchronization between clients, and clock speed synchronization to avoid buffer under/overrun). It is noted, however, that Timestamp Data 440 does not need to be included with every packet 400.

The S/PDIF Channel Status Block Presence Flag 433 may be implemented if the data type is PCM. This flag 433 indicates whether the data has attached S/PDIF CSB information. If present, the CSB data 450 immediately follows the Packet Format field 430 (or the timestamp if Timestamp Data 440 is present).

PCM data that comes from an S/PDIF source has associated channel status block (CSB) accompanying every 192 samples. This data may be transmitted in one of several ways. In an exemplary embodiment, a 4-bit field Block Count indicates how many blocks of PCM data are contained in the packet 400. This number should equal the number of audio samples in the packet divided by 192. It is noted that this number limits the packet length to 192×16 samples, which at 48 KHz is 0.064 seconds of audio.

The data is organized as “Block Count” repetitions of the CSB Format. The CSB Format is given in binary as ‘abX’ where the least significant bit, X, indicates whether the CSB is present for both channels or for just one channel. If X is 1, both channels are present with Channel A first. If X is 0, then the CSB is the same for each channel, and only appears once in the packet (for each of Block Count). Examples are shown in Table 4.

TABLE 4

| Field Value | Channel Indication |
|---|---|
| 001X | all 192 bits of channel status block |
| | are present |
| 010X | only the first 5 bytes of the channel |
| | status block is present (40 bits as per |
| | Phillips UDA 1355H audio codec). |
| All other | Reserved |

The length and interpretation of the CSB data section is dependent on the CSB Format and Block Count as described above. This data describes, among other things, the audio data sample frequency and sample format.

The Discontinuity Flag 434 indicates that there is a discontinuity between the end of this packet 400 and the start of the next packet 400. A soft-mute may be performed to avoid unwanted “plopping” effects, e.g., a cosine roll-off mute over the last 128 samples of this packet, followed by the reverse un-mute over the first 128 samples of the next packet. Soft-mute is particularly desirable for audio servers which may switch from track to track abruptly. Alternatively, the CE devices connected to the encoders may perform their own muting on track transitions. Likewise, when switching from one encoder stream to another, the audio client is responsible for properly muting and un-muting over the stream transition.

Sampling Data field 460 may include sample frequency and format data. Data other than PCM includes self-contained sample frequency and format information. PCM data from an S/PDIF source has its sample frequency and format described in the accompanying CSB data. For all other data (i.e., raw PCM), this information is provided in the Sampling Data field 460.

A 3-bit field may specify the sample frequency. Examples are shown in Table 5.

TABLE 5

| Field Value | Sample Frequency | |
|---|---|---|
| 000 | Not specified - default to 48 KHz | |
| 001 | 48 | KHz |
| 010 | 44.1 | KHz |
| 011 | 32 | KHz |

| | |
|---|---|
| All other | Reserved |

A 5-bit field may specify the format of individual sample format. The least significant bit indicates whether the data is mono (X=0) or stereo (X=1). For stereo data, samples are organized as a sequence of channel A (left), B (right) pairs, starting with the channel A. Examples are shown in Table 6.

TABLE 6

| Field Value | Sample Frequency |
|---|---|
| 0000X | 16 bit LE (little endian) |
| 0001X | 16 bit BE (big endian) |
| 0010X | 24 bit LE packed (3 bytes per sample per |
| | channel) |
| 0011X | 24 bit BE packed |
| 0100X | 24 bit LE unpacked (4 bytes per sample |
| | per channel, with lower order 3 bytes used) |
| 0101X | 24 bit BE unpacked |
| All other | Reserved |

The remainder of packet 400 includes Audio Data 470, wherein the format of this data is determined by the parameters described above.

Still other configurations are also contemplated, and will become readily apparent to those having ordinary skill in the art after becoming familial with the teachings herein.

Exemplary Operations

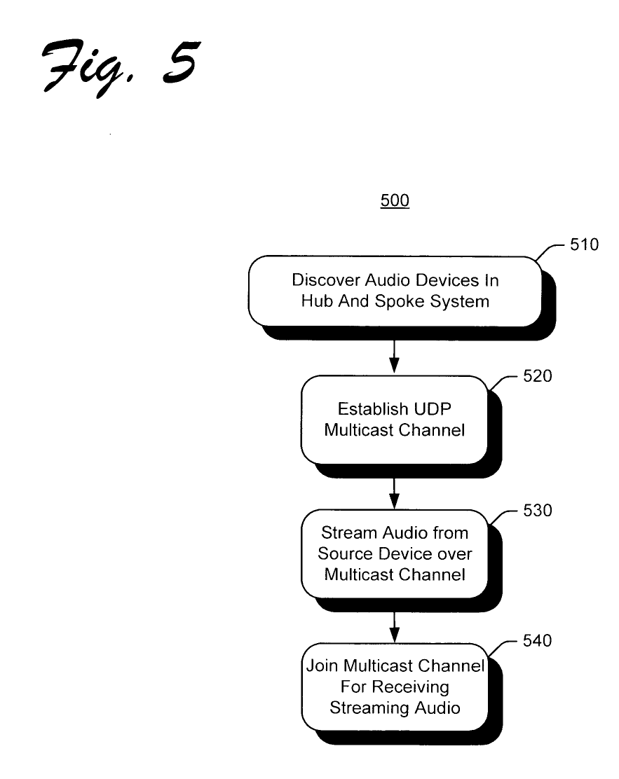

FIG. 5 is a flow diagram showing exemplary operations which may be implemented for audio distribution over IP. Operations 500 may be embodied as logic instructions on one or more computer-readable medium. When executed on a processor, the logic instructions implement the described operations. In an exemplary embodiment, the components and connections depicted in the figures may be used to implement the operations.

In operation 510, audio devices in a hub and spoke system are discovered. For example, the audio distribution system may be logically mapped so that audio source devices, audio output devices, and user-interface devices are known, along with the physical location of each within the network. In option 520, a UDP multicast channel is established. The UDP multicast channel may be established independent of the hub and spoke system, but over the same local area network. In operation 530, audio is streamed from at least one source device over the multicast channel. In operation 540, audio output devices may joint the multicast channel for receiving the streaming audio. For example, audio may be streamed from one or more audio source device in operation 530 in response to a command received at a user-interface device, and output to one or more audio output devices in operation 540. In exemplary embodiments, the audio data is issued via IP multicast for local and/or remote rendering.

The operations shown and described herein are provided to illustrate exemplary embodiments. It is noted that the operations are not limited to the ordering shown, that in other embodiments, additional operations may be included and/or some operations may be omitted.

For purposes of illustration, operations may also be implemented for synchronizing the packets. Such operations may include time-stamping an audio packet for the source (e.g., at a first host machine), then checking the time-stamp for the receiving device (e.g., at a second host machine). Any differences between a clock at the source and a clock at the receiving device are accommodated. The audio packets are then arranged for playback at the receiving device based on the time-stamps (e.g., sequentially).

In addition to the specific embodiments explicitly set forth herein, other aspects and implementations will be apparent to those skilled in the art from consideration of the specification disclosed herein. It is intended that the specification and illustrated embodiments be considered as examples only.

What is claimed is:

1. A system for distributing audio locally over Internet Protocol, comprising:
a first host machine having a process hub (PHub) for handling local communications with a plurality of process spokes (PSpokes) on the first host machine;
a second host machine having a process hub (PHub) for handling local communications with a plurality of process spokes (PSpokes) on the first host machine; and
a local area network connecting the first and second host machines via the respective PHubs;
an audio channel established on the local area network for communicating audio using Internet Protocol between devices controlled by the PSpokes on the first and second host machines.

2. The audio system of claim 1, wherein each PSpoke has a unique address on the local area network.

3. The audio system of claim 1, wherein the devices controlled by the PSpokes are non-network-enabled consumer electronics (CE) audio source devices, input devices, and audio output devices.

4. The audio system of claim 1, wherein the audio is included in a User Datagram Protocol (UDP) packet for IP multicast over the local area network.

5. The audio system of claim 4, wherein the UDP packet includes at least a packet format field and audio data.

6. The audio system of claim 5, wherein the UDP packet includes a packet format field.

7. The audio system of claim 5, wherein the UDP packet includes timestamp data.

8. The audio system of claim 5, wherein the UDP packet includes S/PDIF CSB data.

9. The audio system of claim 5, wherein the UDP packet includes sampling data.

10. A method comprising:
discovering audio devices on a local area network in a hub and spoke system;
establishing a UDP multicast channel between at least some of the audio devices in the local area network; and
streaming audio over the UDP multicast channel.

11. The method of claim 10 further comprising joining the UDP multicast channel for receiving the streaming audio.

12. The method of claim 10 wherein establishing the UDP multicast channel is independent of the hub and spoke system.

13. The method of claim 10 further comprising identifying at least a packet format for the audio data.

14. The method of claim 10 further comprising synchronizing the streaming audio at an audio output device for remote rendering.

15. The method of claim 10 further comprising including timestamp data for synchronizing the streaming audio.

16. The method of claim 10 further comprising including S/PDIF CSB data for the streaming audio.

17. The method of claim 10 further comprising including sampling data for the streaming audio.

18. An audio system comprising:
hub and spoke means for discovering audio devices on a local area network;
means for establishing an audio distribution channel between the discovered audio devices; and
means for multicasting audio data over the audio distribution channel.

19. The audio system of claim 18 further comprising means for synchronizing the audio data.

20. The audio system of claim 18 further comprising packet means for multicasting the audio data, the packet means including the audio data and at least one of the following means for identifying: packet format, timing information, and sampling information.
